(19) United States
(12) Patent Application Publication
(10) Pub. No.: US 2026/0084471 A1
(43) Pub. Date: Mar. 26, 2026

(54) Rotary feedthrough as part of a tire pressure control system of a vehicle and vehicle equipped therewith

(71) Applicant: PTG Reifendruckregelsysteme GmbH, Neuss (DE)

(72) Inventors: Tim Münch, Neuss (DE); Markus Giesen, Neuss (DE)

(21) Appl. No.: 19/331,577

(22) Filed: Sep. 17, 2025

(30) Foreign Application Priority Data
Sep. 23, 2024 (DE) 20 2024 105 459.8

(51) Int. Cl. B60C 23/00

(52) U.S. Cl. CPC B60C 23/00345; B60C 23/00336; B60C 23/00354; B60C 23/00363; B60Y 2410/102

(57) ABSTRACT

A rotary feedthrough as part of a tire pressure control system of a vehicle, comprising a rotor assembly which can be connected in a torque-locking manner to an axle shaft of the vehicle carrying a wheel and a stator assembly which is arranged in a stationary manner in relation to the rotational movement of the rotor assembly. At least one sealed or sealable annular transmission channel is arranged between the rotor assembly and the stator assembly, through which channel, for the purpose of tire pressure control, a pathway for transmitting a gas from the stator assembly to the rotor assembly and/or vice versa is provided. The rotor assembly comprises a rotor part which is arranged at a radial distance from the outer surface of the axle shaft with the rotor-side pathways required for the rotary transmission of a gas, and a driver which can be connected to the axle shaft in a torque-locking manner and which is engaged in a floating manner in the radial direction for the transmission of a rotary movement from the axle shaft to the rotor part. The rotor part is centered with respect to the stator assembly via a bearing, which is arranged between the stator assembly and the rotor part at an axial distance from the driver.

### RELATED APPLICATION

This application claims priority to German application DE 20 2024 105 459.8 filed Sep. 23, 2024, which is incorporated-by-reference herein.

### BACKGROUND

The disclosure relates to a rotary feedthrough as part of a tire pressure control system of a vehicle, comprising a rotor assembly which can be connected in a torque-locking manner to an axle shaft of the vehicle carrying a wheel and a stator assembly which is arranged in a stationary manner in relation to the rotational movement of the rotor assembly, wherein at least one sealed or sealable annular transmission channel is located between the rotor assembly and the stator assembly, through which channel, for the purpose of tire pressure control, a pathway for transmitting a gas from the stator assembly to the rotor assembly and/or vice versa is provided. The disclosure further relates to a vehicle with pneumatic tires equipped with rotary feedthroughs of such a tire pressure control system.

Tire pressure control systems are used in motor vehicles, for example in commercial vehicles, such as trucks, tractors or earth-moving machines, in order to be able to adapt the tire pressure in the tire to different operating situations of the motor vehicle. The tire pressure is adjusted primarily depending on the ground to be driven on and/or the load. The contact surface of the tire can be changed by the tire pressure. A tire has a larger contact area at a lower tire pressure than with a higher tire pressure. For this reason, a driver will prefer to drive with a lower tire pressure and a larger contact area on soft ground than on a paved road. The tire pressure can also be changed depending on the respective load condition.

Tire pressure control systems of this type have a rotary feedthrough in order to transmit compressed air from a vehicle-side compressed-air source to the rotatably mounted wheel in order to increase the tire internal pressure. Such a rotary feedthrough comprises a stator assembly arranged on the vehicle side and a rotor assembly arranged on the wheel side and separated from the latter by a movement gap. Depending on the design of the rotary feedthrough, both assemblies are arranged either axially or radially relative to each other. On the wheel side, an air line leading to the rim of the wheel is provided on the rotor of the rotary feedthrough. This engages through the rim in an opening and opens into the tire interior. A controllable valve is typically interposed in the wheel-side air line, which valve is opened for the tire pressure control process and is closed after completion of the process. The compressed air itself is provided by a compressor arranged on the vehicle side. The compressor used is typically the compressor that is already present for operating the brake system in commercial vehicles.

EP 2 586 630 B1 discloses a rotary feedthrough, which can be mounted in a simple manner on an axle shaft carrying a wheel and which has a smaller installation space in the axial direction. The rotor assembly and the stator assembly of this rotary feedthrough are located in a radial arrangement with respect to one another. A clamping ring that can be braced in a torque-locking manner with the axle shaft is used to connect the rotor assembly to the axle shaft.

Rotary feedthroughs of this type with a radial arrangement of the stator assembly and rotor assembly are often located in an internal arrangement relative to the wheel supported by the axle shaft, and are therefore located between the wheel and an axle adjuster. Increasingly higher loads on the axles and thus on the axle shafts of vehicles equipped with tire pressure control systems using such rotary feedthroughs can result in axle deformations or axle shaft deformations, which sometimes leads to a radial displacement of the axis of rotation of the axle shafts and thus to an axle shaft deformation eccentricity. Due to the radial arrangement of the rotor assembly and stator assembly with the pathways located between these assemblies for gas transmission (air transmission), this can lead to leaks at the seals between the rotor assembly and stator assembly or also to damage to them. In such a case, a certain movement of the rotor assembly on the axle shaft can also occur, which in turn can lead to functional impairments or even to the failure of such a rotary feedthrough.

The foregoing examples of the related art and limitations therewith are intended to be illustrative, not exclusive. Other limitations will become apparent to those skilled in the art upon a reading of the specification and a study of the drawings.

### SUMMARY

The following embodiments and aspects thereof are described and depicted in conjunction with systems, tools and methods which are meant to be illustrative, not limiting in scope. In various embodiments, one or more problems have been reduced or eliminated, while other embodiments are directed to other improvements.

One aspect of the disclosure is to further develop a rotary feedthrough of the type mentioned at the beginning in such a way that the rotary feedthrough is insensitive to axle deformation eccentricities that may occur.

This may be achieved by a rotary feedthrough of the type mentioned at the outset wherein the rotor assembly comprises a rotor part, which is arranged at a radial distance from the outer surface of the axle shaft with the rotor-side pathway or pathways required for the rotary transmission of a gas, as well as a driver which can be connected to the axle shaft in a torque-locking manner and which is engaged in a floating manner with the rotor part in the radial direction for the transmission of a rotary movement from the axle shaft to the rotor part, and wherein the rotor part is centered with respect to the stator assembly via a bearing, which is arranged between the stator assembly and the rotor part at an axial distance from the driver.

In this rotary feedthrough, the rotor assembly is designed in multiple parts and comprises a rotor part arranged at a radial distance from the lateral surface of the axle shaft and a driver via which the rotation of the axle shaft is transmitted to the rotor. This radial distance is preferably dimensioned slightly greater than the greatest axle deformation eccentricity to be compensated for. The driver can be connected to the axle shaft in a torque-locking manner or connected to an axle shaft when the rotary feedthrough is mounted on a vehicle. It is advantageous to effect the torque transmission from the axle shaft to the driver via a form-locking connection of these two parts. The driver can then be pushed onto the axle shaft and it is possible that the driver remains movable with a certain play in the axial direction and is not locked. The output of the driver for transmitting the rotational movement to the rotor part is designed to float in the radial direction and is thus decoupled from axle deformation eccentricities. Axle deformation eccentricities are therefore not transferred from the driver to the rotor part, with the result that the rotary feedthrough is insensitive to any eccentricities of the axle shaft that may occur. The rotor part is centered with respect to the stator assembly by a bearing which is interposed in the radial direction and which is preferably designed as a rolling body bearing, in particular as a ball bearing. The provision of such a bearing renders centering of the rotor assembly on the axle shaft obsolete and thus enables the radially floating coupling of the rotor assembly and driver. As a result of the floating mounting of the kinematic coupling between the driver and the rotor part, no forces and torques caused by tilting are transmitted to the rotor part when axle deformation eccentricities occur or due to otherwise caused axle or axle shaft eccentricities, so that the seals located between the rotor part and the stator assembly to limit the fluid pathway are not subjected to any additional load even when axle eccentricities occur.

The torque-locking connection of the driver to the axle shaft takes place without play in the radial direction and can be provided in different ways. According to some embodiments, the axle shaft has one or more rotary driving contours. In dimensional and geometrical adaptation to this, the driver has an axle shaft recess with complementary contour geometry. In such a configuration, the driver can be pushed onto the axle shaft in a simple manner. In addition, in such a configuration, the driver can also be connected kinematically to the rotor part with a certain axial movement clearance. A certain axial play of the driver relative to the axle shaft supports the decoupling effect between the driver and the rotor part desired with this rotary feedthrough.

According some embodiments, the kinematic connection of the driver to the rotor part is provided wherein one of the two parts to be coupled to one another—driver or rotor part—has a coupling recess open towards the respective other part—rotor part or driver. A guide element of the respective other part, which is designed in the manner of a sliding block, engages in this recess. The guide element is designed to receive and transmit the movement of the driver or the rotor part with its side surfaces pointing in the two opposite directions of rotation. It is essential that the guide element is arranged movably in the radial direction in the coupling recess. Thus, the radial extension of the coupling recess is greater than the radial extension of the guide element. Preferably, in the central alignment, the radial play of the guide element in the coupling recess in both radial directions is greater than the expected maximum axle shaft deformation eccentricity. The engagement position of the guide element in the coupling recess is preferably configured in such a way that, if the axis of rotation of the axle shaft and that of the rotor part are homoaxial, there is therefore no axle eccentricity, the guide element is arranged in the center or approximately center in the coupling recess, so that it is movable in the radial direction to the same extent both in the direction of the axis of rotation and in the opposite direction. In the direction of rotation, there is preferably only so much play between the guide element and the walls delimiting the coupling recess that the radial movability of the guide element in the coupling recess is ensured.

For example, a pin can be used as the guide element, which pin is guided in a coupling recess designed in the manner of an elongated hole. It is advantageous if the guide element has uncurved or at least largely uncurved side surfaces pointing in the directions of rotation, via which the rotational movement is transmitted. This ensures that the surface pressure in contact with the driver is significantly lower than the maximum tolerable surface pressure. Typically, the torque coupling between the driver and the rotor part will be designed in such a way that the radial component of all driver movements as a result of occurring axle shaft deformation eccentricities are compensated. For this purpose, it is provided in some embodiments that the guide element engaging in the coupling recess is pivotably mounted, which can be made possible, for example, by arranging the guide piece on a sleeve or a bolt.

According to some embodiments, in the axial direction, the driver is connected to the rotor part by a bolt. This connection preferably takes place with axial play, as already indicated above. On the side opposite the rotor part, for example, a disk is used for axial fixing or axial mobility limitation. An annular disk is typically inserted between the driver and the end face of the rotor part facing the driver in order to avoid wear phenomena on the rotor part. According to some embodiments, such an annular disk also serves to limit the axial play of the driver on the rotor part side.

According to some embodiments, the driver of the rotor assembly is designed as a disk, in particular as a non-rotationally symmetrical disk with a long axis and a short axis, with a centrally arranged axle shaft recess, via which the driver can be fitted in a form-locking manner onto an axle shaft designed with at least one rotary driving contour.

The rotational movement is preferably transmitted from the driver to the rotor part only at one position as seen in the circumferential direction. The driver, which also extends from its connection to the axle shaft in the direction of the coupling recess or the guide element and on the side diametrically opposite with respect to its axis of rotation, is limited with respect to its axial movability not only in the region of the guide element, but also in its diametrically opposite extension. While, on one side, the rotor part or a spacer piece, for example designed as an annular disk, which is optionally inserted between the rotor part and the driver is used, a disk held by a bolt is also used on the side opposite the force transmission to limit the axial mobility of the driver with respect to the rotor part on the side opposite the rotor part. This bolt extends through a bolt passage opening of the driver. The clear width of this bolt passage opening is dimensioned sufficiently wide so that the possible specified axle shaft eccentricity compensation is not impaired.

The rotary feedthrough itself can be designed as a single-channel or multi-channel. The seals for providing the fluid pathways can either be permanently active or can be activated. The mechanism by which a possible activation takes place is irrelevant in connection with the rotary feedthrough according to the invention.

In addition to aspects and embodiments described above, further aspects and embodiments will become apparent by reference to the appended drawings, wherein like reference numerals generally designate corresponding structures in the several views.

### BRIEF DESCRIPTION OF THE DRAWINGS

The disclosure is described hereinafter with reference to the drawings showing an example embodiment, where:

FIG. 1 shows a schematic sectional view of a pneumatic-tired wheel mounted on an axle shaft of a motor vehicle, not otherwise shown, with a rotary feedthrough mounted on the axle shaft,

FIG. 2 shows a perspective view of the rotary feedthrough of FIG. 1,

FIG. 3 shows a front side view of the rotary feedthrough of FIG. 2 with an angle of view onto the end of the axle shaft in the direction of the rotary feedthrough,

FIG. 4 shows a sectional view through the rotary feedthrough along line A-A of FIG. 3,

FIG. 5 shows an enlarged representation of detail section X shown in FIG. 4,

FIG. 6 shows an enlarged representation of detail section Y shown in FIG. 4,

FIG. 7 shows a cross-section through the rotary feedthrough of the preceding figures in the plane of the driver connected to the axle shaft in a torque-transmitting manner as part of the rotor assembly, and

FIG. 8 shows an enlarged representation of detail section Z shown in FIG. 7.

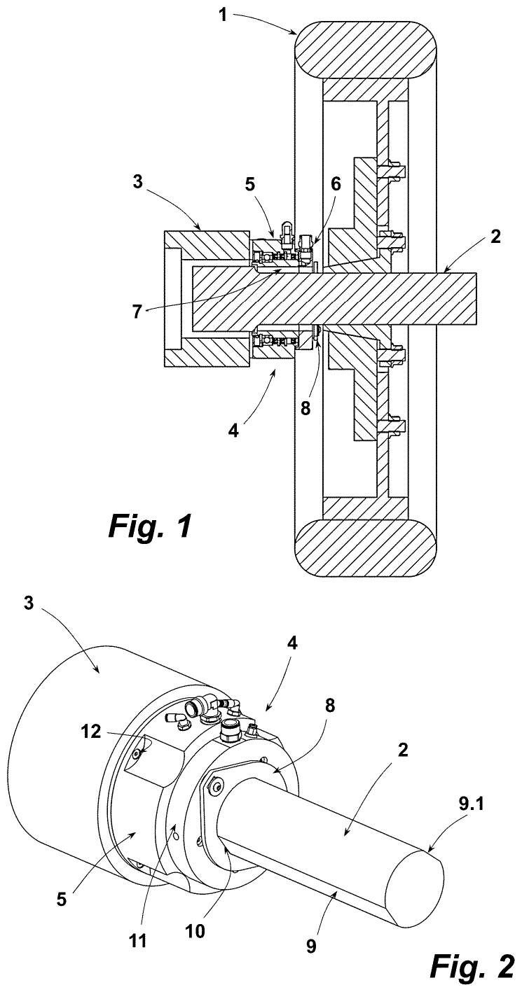

Before explaining the depicted embodiments, it is to be understood that the invention is not limited in application to the details of the particular arrangements shown, since the invention is capable of other embodiments. The embodiments and figures disclosed herein are to be considered illustrative rather than limiting.

### DETAILED DESCRIPTION

A pneumatic tire 1 is mounted on an axle shaft 2 and is connected to the latter in a torque-locking manner known per se. The axle shaft 2 extends into an indicated axle adjuster 3 arranged in the direction of the chassis of the vehicle carrying the axle shaft 2. The vehicle has a tire pressure control system, of which only the rotary feedthrough 4 is shown in the figure. An air pathway is provided via the rotary feedthrough 4 in order to increase or decrease the air pressure in the pneumatic tire 1 in accordance with the desired requirements. The rotary feedthrough 4 comprises a stator assembly 5. In the example embodiment shown, the stator assembly 5 is connected to the axle adjuster 3 in a torque-locking and stationary manner, typically flange-mounted on the axle adjuster 3. A rotor assembly 6 which is coupled to the rotational movement of the axle shaft 2 is radially arranged with respect to the stator assembly 5. The stator assembly 5 has the necessary connections for connecting the air lines. The rotor assembly 6 has a plurality of air connections via which the fluid pathway of the rotary feedthrough 4 is connected to the interior of the pneumatic tire 1, typically its wheel valve. The rotor assembly 6 has a rotor part 7 which is spaced apart from the outer surface of the axle shaft 2 with its inner side facing the axle shaft 2. Associated with the rotor assembly 6 is also a driver 8 designed as a disk in the illustrated embodiment. This driver is connected to the axle shaft 2 in a torque-locking manner and in the illustrated example embodiment by means of a form lock and serves to transmit a rotational movement of the axle shaft 2 and thus of the pneumatic tire 1 to the rotor part 7.

The axle shaft 2 has two flat rotary driving contours 9, 9.1 (see FIG. 2). The planes of the rotary driving contours 9, 9.1 are arranged at an acute angle to one another, and thus do not run parallel to one another in the illustrated example embodiment. These rotary driving contours 9, 9.1 serve for the form-locking connection of the driver 8 and the pneumatic tire 1 to the axle shaft 2. The driver 8 designed as a disk has an axle shaft recess 10, the inner contour of which corresponds to the outer contour of the axle shaft 2. A connecting ring 11 belonging to the rotor assembly 6 can be seen from the rotor part 7 of the rotor assembly 6 in the perspective view of FIG. 2. This carries the rotor-side connections and contains the rotor-part-side fluid pathways. The corresponding fluid connections of the stator assembly 5 can also be clearly seen in FIG. 2. The stator assembly 5 is connected to the end face of the axle adjuster 3 facing the pneumatic tire 1 by means of clamping bolts 12 distributed over the circumference.

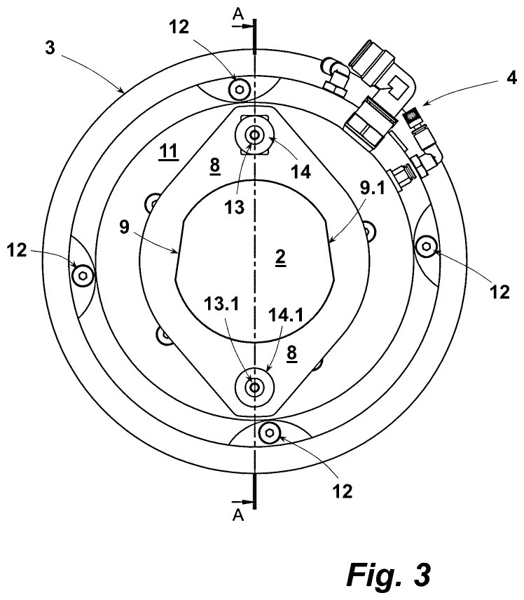

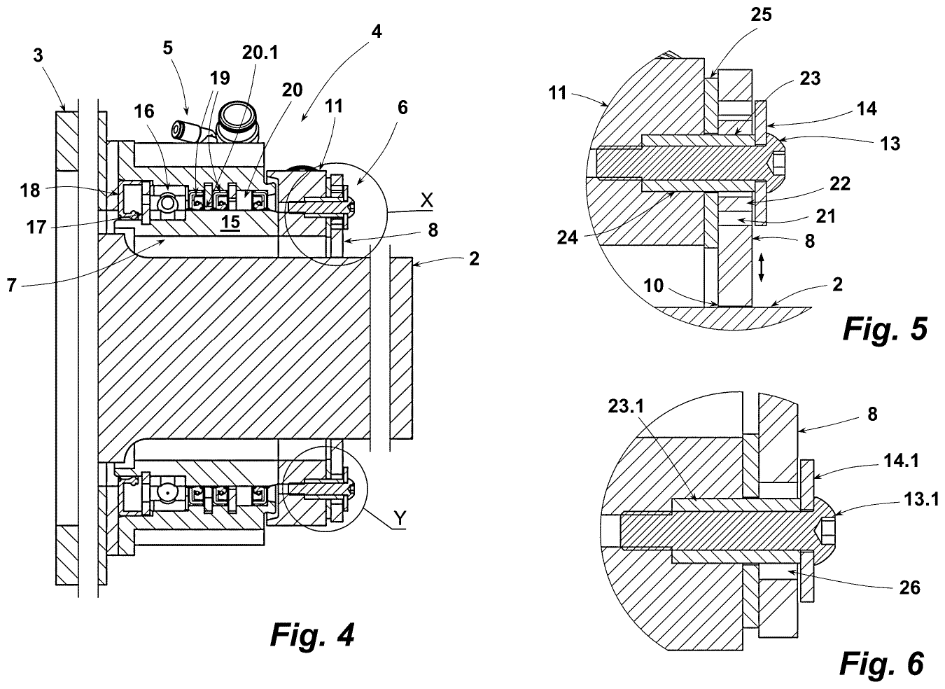

The driver 8 is pushed onto the axle shaft 2 and connected by means of bolts 13, 13.1 (see FIG. 3) to the rotor part 7 with a certain axial play (see also FIG. 4). Below their bolt head, the bolts 13, 13.1 each carry a disk 14, 14.1 for limiting an axial play with which the driver 8 is held on the rotor part 7 or its connecting ring 11.

The rotor part 7, which is arranged with its radially inward-pointing circumferential surface at a distance from the circumferential surface of the axle shaft 2, has, in addition to the connecting ring 11, a rotor sleeve 15. This is arranged concentrically on the inside with respect to the stator assembly 5. The connecting ring 11 and the rotor sleeve 15 form a unit as the rotor part 7 and are connected to one another in a torque-locking manner, not shown. The rotor sleeve 15 and thus the rotor part 7 are centered via a bearing 16 located between the stator assembly 5 and the rotor assembly 6 arranged on the inside. In the example embodiment shown, the bearing 16 is a ball bearing. On the mutually facing sides of the stator assembly 5 and the rotor sleeve 15, there is a recess as a bearing seat. The shoulders formed in this way in the direction of the connecting ring 11 serve as a stop for the bearing 16. In the direction of the axle adjuster 3, the bearing 16 is held by a locking washer 17 and additionally sealed in this direction by a seal 18. An adapter ring is inserted between the stator assembly 5 and the axle adjuster 3, by means of which the seal 18 is also fixed.

An air transmission gap arranged between the stator assembly 5 and the rotor assembly 6 or its rotor sleeve 15 is subdivided into individual air transmission channels 20, 20.1 by a plurality of circumferential seals 19. The seals 19 serve to seal the air transmission channels 20, 20.1 for air transmission from the stator assembly 5 to the rotor assembly 6 or vice versa. The air transmission channels 20, 20.1 continue into axial transmission channels for transmitting air from the air transmission channels 20, 20.1 into the corresponding air pathways in the connecting ring 11 and to the air connections on the rotor assembly side. The measures in this respect are known from conventional rotary feedthroughs, as described, for example, in EP 2 586 630 B1, and therefore do not require any further explanation at this point.

Torque is transmitted from the driver 8 to the connecting ring 11 of the rotor assembly 6 in a floating manner in the radial direction. The rotor assembly 6 is thus decoupled from possible radial movements of the driver 8. Radial movements of the driver 8 can occur in the event of axle shaft deformations, for example as a result of a high axle load. To transmit the rotational movement of the axle shaft 2 to the rotor part 7, the driver 8 has a coupling recess 21 in which a guide element 22 is arranged. The guide element 22 functions as a sliding block in the radial direction. The guide element 22 is arranged movably in this direction in the coupling recess 21. The guide element 22 is seated rotatably on a sleeve 23, against the end face of which, facing away from the connecting ring 6, the disk 14 held by the bolt 13 acts. By means of the disk 14, the sleeve 23 is pressed into a sleeve bore 24 of the connecting ring 11. At the same time, the sleeve 23 serves the purpose that a certain play acting in the axial direction remains between the disk 14 and the upper side of the driver 8 facing the disk 14 (see also FIG. 5). In order to avoid direct contact between the driver 8 and the end face of the connecting ring 11 facing the driver 8, a sliding ring washer 25 is arranged between these two components of the rotary feedthrough 4. In the illustrated embodiment, the rotational movement is transmitted from the driver 8 to the connecting ring 11 of the rotor part 7 exclusively via the guide element 22 arranged in the coupling recess 20.

The driver 8 is also axially secured on its side diametrically opposite the coupling recess 21 by a bolt 13.1 carrying a disk 14.1. A sleeve 23.1 is also used at this point to leave the desired axial play between the driver 8 and the axle shaft 2.

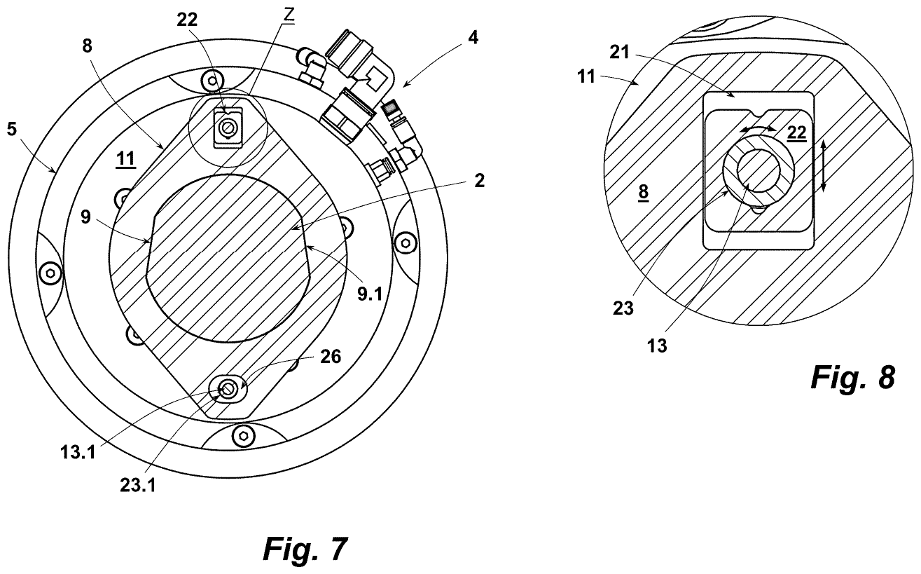

The coupling recess 21 of the example embodiment shown has a rectangular contour geometry, as can be seen from FIGS. 7 and 8. The guide element 22 inserted into the coupling recess 21 is also rectangular. While the guide element 22 fits into the coupling recess 21 more or less without play in the direction of the rotational movement to be transmitted, the radial extension of the guide element 22 is significantly shorter than the corresponding width of the coupling recess 21. The play of the guide element 22 within the coupling recess 21 in the direction of the rotation to be transmitted and thus in the direction of the two longitudinal side walls of the coupling recess 21 is dimensioned such that the driver 8 can be moved freely in the radial direction relative to the guide element 22. The possible amount of movement is defined by the free space of the coupling recess 21 located in the radial direction between the guide element 22 and the radially arranged side walls of the coupling recess 21. This free space is slightly larger than the axle shaft deformation eccentricities to be expected in the radial direction and to be compensated for by the floating torque transmission. If axle shaft deformation eccentricities occur, the driver 8 can thus be moved in the radial direction without this movement being transmitted to the guide element 22 and thus to the rotor part 7. For this reason, the output of the driver 8 is designed to float relative to the rotor part in the radial direction to the axis of rotation of the axle shaft 2.

The axial limitation of the movement of the driver 8 on the side opposite the coupling recess 21 by the bolt 13.1 is also designed such that the bolt passage opening 26 of the driver 8 is sufficiently wide so that, in the event of a radial movement of the driver 8, this movement is not limited by the shaft of the bolt 13.1. A floating coupling of the driver 8 to the rotor part 7 in any desired radial direction and thus in the directions of movement of the driver 8, which also have only a radial component, is thus provided. The seals 19 are thus decoupled from such axle shaft movements.

The connecting ring 11 engages over the rotor sleeve 15 in the radial direction and extends with an axial extension over an extension of the stator assembly pointing in the opposite direction. In this way, a labyrinth seal acting in the radial direction is provided between the connecting ring 11 and the stator assembly 5, as can be seen from FIG. 4.

The invention has been described in the context of example embodiments. Without departing from the scope of the claims, there are numerous other possible designs, options, modifications, permutations, additions, and combinations for a person skilled in the art to implement the invention, without these having to be shown or explained in detail herein. The claims should therefore be interpreted to include all such designs, options, modifications, permutations, additions, and combinations. Each embodiment described herein has numerous equivalents. Terms and expressions herein are used as terms and expressions of description and not of limitation, and there is no intention in the use thereof to exclude any equivalents of the features shown or described, or portions thereof.

### LIST OF REFERENCE NUMERALS

1 pneumatic tire
2 axle shaft
3 axle adjuster
4 rotary feedthrough
5 stator assembly
6 rotor assembly
7 rotor part
8 driver
9,9.1 rotary driving contour
10 axle shaft recess
11 connecting ring
12 clamping bolt
13, 13.1 bolt
14,14.1 disk
15 rotor sleeve
16 bearing
17 locking washer
18 seal
19, 19.1 seal
20,20.1 air transmission channel
21 coupling recess
22 guide element
23,23.1 sleeve
24 sleeve bore
25 sliding ring washer
26 bolt passage opening

1. A rotary feedthrough as part of a tire pressure control system of a vehicle, comprising:
a rotor assembly which is connectable in a torque-locking manner to an axle shaft of the vehicle carrying a wheel, and
a stator assembly which is arranged in a stationary manner with respect to the rotational movement of the rotor assembly,
wherein at least one sealed or sealable annular transmission channel is arranged between the rotor assembly and the stator assembly providing a pathway for transmitting a gas from the stator assembly to the rotor assembly and/or vice versa for purposes of tire pressure control,
wherein the rotor assembly comprises a rotor part arranged at a radial distance from the outer surface of the axle shaft with the one or more rotor-side pathways required for gas transmission, and a driver which is connectable to the axle shaft in a torque-locking manner and which is engaged in a floating manner in the radial direction in order to transmit a rotational movement from the axle shaft to the rotor part, and
wherein the rotor part is centered with respect to the stator assembly via a bearing arranged between the stator assembly and the rotor part at an axial distance from the driver.

2. The rotary feedthrough of claim 1, wherein:
the driver has a coupling recess, which is open towards the rotor part at a radial distance from the outer surface of the axle shaft to be connected, into which a guide element of the rotor part engages for torque transmission, wherein the guide element is designed with its side surfaces facing in a direction of rotation for receiving a rotational movement of the driver and is arranged movably in the radial direction in the coupling recess,
and/or
a side of the rotor part facing the driver has a coupling recess for torque transmission from the driver, into which a guide element of the driver designed as a sliding block engages, wherein the guide element is designed with its side surfaces facing in a direction of rotation for receiving a rotational movement of the driver and is arranged movably in the radial direction in the coupling recess.

3. The rotary feedthrough of claim 2, wherein the guide element is pivotably mounted.

4. The rotary feedthrough of claim 2, wherein the rotational movement between the driver and the rotor part is transmitted only via the guide element engaging in the coupling recess.

5. The rotary feedthrough of claim 1, wherein the driver of the rotor assembly is designed as a disk with an axle shaft recess.

6. The rotary feedthrough of claim 5, characterized in that the outer surface of the axle shaft to which the rotary feedthrough is to be connected is provided with at least one rotary driving contour, and the contour geometry of the axle shaft recess of the driver is designed to be complementary to the contour geometry of the axle shaft with its at least one rotary driving contour.

7. The rotary feedthrough of claim 5, wherein an axial mobility of the driver with respect to the rotor part is limited by at least one bolt which is fixed to the rotor part and engages through the driver and has a disk held by the bolt.

8. The rotary feedthrough of claim 7, wherein:
the driver has a coupling recess, which is open towards the rotor part at a radial distance from the outer surface of the axle shaft to be connected, into which a guide element of the rotor part engages for torque transmission, wherein the guide element is designed with its side surfaces facing in a direction of rotation for receiving a rotational movement of the driver and is arranged movably in the radial direction in the coupling recess, p1 and/or p1 a side of the rotor part facing the driver has a coupling recess for torque transmission from the driver, into which a guide element of the driver designed as a sliding block engages, wherein the guide element is designed with its side surfaces facing in a direction of rotation for receiving a rotational movement of the driver and is arranged movably in the radial direction in the coupling recess.

9. The rotary feedthrough of claim 8, wherein the axial mobility of the driver with respect to the rotor part is limited on the side of the driver opposite the torque transmission from the driver to the rotor part with respect to the axle shaft, wherein a bolt inserted in this opposing position reaches through the driver with a disk supported thereon and a bolt passage opening of the driver is sufficiently wide such that mobility of the guide element in directions of movement which also have only a radial component is not limited with respect to the driver through the bolt passage opening within the scope of an axle shaft eccentricity compensation.

10. The rotary feedthrough of claim 1, wherein the bearing arranged between the stator assembly and the rotor part is a rolling body bearing.

11. The rotary feedthrough of claim 10, wherein balls are inserted in the bearing as rolling bodies.

12. The rotary feedthrough of claim 1, wherein the rotor assembly is positioned axially with respect to the stator assembly by the bearing.

13. The rotary feedthrough of claim 1, wherein the stator assembly is flange-mounted on an axle adjuster of the axle shaft.

14. The rotary feedthrough of claim 13, wherein the stator assembly is connected to the axle adjuster with interposition of an adapter ring.

15. The rotary feedthrough of claim 1, wherein the rotor part comprises a rotor sleeve carrying the bearing and a connecting ring connected thereto in a torque-locking manner, the connecting ring having at least one connecting piece for connecting a gas line leading to a wheel valve, and wherein a labyrinth seal acting in the radial direction is provided between the connecting ring and the stator assembly.

16. A pneumatic-tired vehicle with a tire pressure control system via which tire pressure can be controlled at least in two tires of an axle lying opposite one another, wherein axle shafts carrying these wheels are provided with a rotary feedthrough according to claim 1.
